(19) United States
(12) Patent Application Publication
(10) Pub. No.: US 2014/0198899 A1
(43) Pub. Date: Jul. 17, 2014

(54) DUAL ENERGY IMAGING SYSTEM

(71) Applicants: Vitaliy Ziskin, Brighton, MA (US); Boris Oreper, Newton, MA (US)

(72) Inventors: Vitaliy Ziskin, Brighton, MA (US); Boris Oreper, Newton, MA (US)

(73) Assignee: L-3 Communications Security and Detection Systems, Inc., Woburn, MA (US)

(21) Appl. No.: 13/739,871

(22) Filed: Jan. 11, 2013

(51) Int. Cl. G01N 23/04

(52) U.S. Cl. CPC G01N 23/04
USPC 378/53; 378/62

(57) ABSTRACT

An inspection system that makes dual energy measurements with a detector array that has selective placement of filter elements adjacent a subset of detectors in the array to provide at least two subsets of detector elements sensitive to X-rays of different energies. Dual energy measurements may be made on objects of interest within an item under inspection by forming a volumetric image using measurements from detectors in a first of the subsets and synthetic readings computed from measurements made with detectors in the array, including those that are filtered. The volumetric image may be used to identify the objects of interest to and source points that, for each object of interest, provide a low interference path to one of the detectors in the second of the subsets. Measurements made with radiation emanating from those source points are used for dual energy analysis of the objects of interest.

### FIELD OF THE INVENTION

The invention relates to X-ray inspection systems that form volumetric images of items under inspection using dual energy X-ray measurements to obtain information on properties of objects in the items.

### BACKGROUND OF THE INVENTION

X-ray imaging technology has been employed in a wide range of applications from medical imaging to detection of unauthorized objects or materials in baggage, cargo or other containers generally opaque to the human eye. X-ray imaging typically includes passing radiation (i.e., X-rays) through an object to be imaged. X-rays from a source passing through the object interact with the internal structures of the object and are altered according to characteristics of material the X-rays encounter. By measuring changes in the X-ray radiation that exits the item, information related to characteristics of the material in the item, such as density, atomic structure and/or atomic number, etc., may be obtained.

To measure atomic number, X-ray radiation exiting the object is measured at two or more energy levels. Because materials of different atomic numbers respond differently to X-rays of different energy levels, measuring interaction at multiple X-ray energy levels provides an indication of the atomic number of the material with which the X-ray radiation has interacted. In some X-ray inspection systems used for security screening of baggage or other items, dual energy measurements are used in combination with density measurements to classify objects within an item under inspection. Such systems may use automated detection algorithms to analyze X-ray images that detect objects and classify them as threat or non-threat objects based on size, shape, density and material composition. These systems are called “dual energy systems” because useful distinctions between materials can generally be made using any two energy levels. Though, some dual energy systems make measurements at more than two energy levels.

The energy level of X-rays is determined by characteristics of the components used to generate the X-ray radiation. Some X-ray inspection systems have sources that use electron beams as part of their X-ray generation subsystems. In these systems, an e-beam is directed to impinge on the surface of a target that is responsive to the e-beam. The target may be formed from or plated with tungsten, molybdenum, gold, metal, or other material that emits X-rays in response to an electron beam impinging on its surface. The target material is one factor that can impact the energy of emitted X-rays. A second factor is a voltage used to accelerate electrons toward the target. An electron beam may be generated, from an electron source called a cathode, and a voltage may be applied between the cathode and target to accelerate electrons toward the target.

Some inspection systems employ multiple X-ray generation components, each configured to emit radiation at a different energy level. Though, other inspection systems may employ a switching power supply to change the voltage level within one X-ray generation subsystem to control the subsystem to emit X-rays of different energy levels at different times.

An alternative approach for making multi-energy X-ray measurements is to use different types of detectors. Some detectors are preferentially sensitive to radiation of a specific energy level. The output of such detectors can be taken as an indication of radiation at those energy levels. By illuminating an item under inspection with X-ray radiation over a broad spectrum, the output of detectors sensitive to radiation of different energies may be used to form dual energy measurements.

In addition to classifying systems based on whether they form single energy or dual energy images, inspection systems may be classified based on the type of images they form. Multiple types of X-ray inspection systems are known. Two types are projection imaging systems and volumetric imaging systems. In a projection imaging system, an X-ray generating component is positioned on one side of an item under inspection and detectors are positioned on an opposite side. Radiation passes through the item under inspection predominately in a single direction. As a result, an image formed with a projection imaging system is a two-dimensional representation of the item, with objects inside the item appearing as if they were projected into a plane perpendicular to the direction of the X-rays.

In contrast, in a volumetric imaging system, radiation passes through the item under inspection from multiple directions. Measurements of the radiation exiting the item under inspection are collected and, through computer processing, a three-dimensional representation of objects within the item is computed. One class of volumetric imaging system is called a computed tomography (CT) system.

Conventional CT systems establish a circular relationship between an X-ray generating component and X-ray detectors. One approach for forming the circular relationship is to mount both the X-ray generating component and detectors on a rotating gantry that moves relative to the item under inspection. An alternative approach is to control an X-ray generating component to alter the location from which it emits X-ray radiation. Such control can be achieved in an e-beam system by steering the e-beam to strike different locations on the target at different times.

An e-beam may be steered magnetically by bending the beam using one or more magnetic coils, herein referred to as steering coils. In general, the e-beam propagates in a vacuum chamber until the e-beam impinges on the target. Various methods (e.g., bending an electron beam using one or more magnets) of providing an e-beam along a desired path over a surface of the target are well known in the art.

### SUMMARY OF INVENTION

Embodiments of the invention provide improved systems and methods for forming dual energy X-ray images. In some embodiments, an inspection system comprises detectors that are sensitive to X-ray radiation of different energy levels. As an example, a volumetric system may include a sufficient number of detectors at a first energy to form a volumetric image of an item under inspection. A number of detectors sensitive to X-rays at a different energy may be incorporated into the system. These detectors may be sensitive to X-rays at a second energy due to filter elements adjacent detectors sensitive to the first energy. A filter element may be a film or coating placed on a detector to attenuate the X-rays at the first energy more than X-rays at the second energy.

In some embodiments, detectors sensitive to both the first energy and the second energy may be formed from an array of a single type of detector by placing filter elements over a sub-set of the detectors in the array. Such an approach can lead to a low cost construction. However, this construction technique leaves gaps in the array of detectors used to form the volumetric image where detectors of the array are converted to detectors sensitive to the second energy. Computational techniques may be used to generate values representative of measurements of the first energy in these gaps. For example, an interpolation technique, using measurements from detectors of the first energy adjacent the gaps may be used to generate values useful in constructing a volumetric image. Though in some embodiments, an interpolation technique may use information acquired by detectors of more than one energy to more accurately determine energy values in the gaps.

A volumetric image formed using the detectors at the first energy level may be analyzed to identify objects within the item under inspection. Preferential paths through the item under inspection to the detectors of the second energy level can be identified. In some embodiments, the preferential paths pass through identified objects for which atomic number information is to be used for threat assessment. Radiation travels along the preferential paths and passes through these objects without substantial interference from other objects in the item under inspection. Once these paths are identified, points of origin of radiation that travel along these paths are identified. Measurements made with the detectors of the second energy level while the X-ray generation subsystem is generating radiation from these points of origin are obtained and used for processing dual energy image data.

Such an approach of making dual energy measurements may be used in systems that can control the point of origin of X-rays through mechanical motion or through steering an electron beam or in any other suitable fashion.

Accordingly, in some aspects, the invention relates to an inspection system with an inspection area. At least one x-ray source may be adapted to emit x-ray radiation into the inspection area at a first energy and a second energy. A plurality of detectors may be positioned to receive x-ray radiation from the at least one x-ray source after passing through the inspection area. The plurality of detectors may comprise a first and second subset. A plurality of filter elements may be positioned adjacent detectors of the second subset of the plurality of detectors. A processor may be used to construct a single-energy image of a slice through an item within the inspection area from outputs of the first subset of detectors when irradiated by the at least one x-ray source. At locations where no x-ray radiation is measured by a detector of the first subset of detectors, data may be calculated for the construction of the single-energy image of the slice by interpolating outputs of the first subset of detectors adjacent the locations where no x-ray radiation is measured. The second subset of the plurality of detectors may consist of fewer detectors than the first subset of the plurality of detectors.

In another aspect, the invention relates to a method of operating an inspection system that includes using at least one source and an array of detectors, to measure attenuation of x-rays at a first energy by an object in an inspection area. The array may comprise a first plurality of detectors and gaps between a portion of the first plurality of detectors, An image of a slice through the object may be computed based on the measured attenuation at a first energy and one or more computed values, wherein the computed values include values representative of attenuation of x-rays from the source to one or more of the gaps. The image may be analyzed to determine whether an object of interest is present. When an object of interest is present, a source position and a detector of a second plurality of detectors may be selected such that a path between the selected source position and selected detector passes through the object of interest. Attenuation of x-rays at a second energy by the object in the inspection area may be measured, and an atomic number of the object may be computed based on the measured attenuation at the second energy and a portion of the measured attenuation at the first energy level.

In another aspect, the invention relates to a method of operating an inspection system that includes using at least one source and an array of detectors, the array comprising a first plurality of detectors and gaps between a portion of the first plurality of detectors, to measure attenuation of x-rays at a first energy by an object in an inspection area. An image of a slice through the object may be computed based on the measured attenuation at a first energy. The array of detectors may comprise a first subset and a second subset. A plurality of filter elements may be positioned adjacent detectors of the second subset of the plurality of detectors such that a path between a selected source position and a selected detector of the second subset of detectors passes through a filter element adjacent to the selected detector.

The foregoing is a non-limiting summary of the invention and one of skill in the art will recognize other inventive concepts in the following description.

### BRIEF DESCRIPTION OF THE DRAWINGS

FIG. 1 illustrates a conventional circular geometry x-ray generation subsystem using e-beam technology;

FIG. 2 illustrates an arbitrary geometry target and detector array using e-beam technology, in accordance with one embodiment of the present invention;

FIG. 3 illustrates near-side detector irradiation occurring in the arbitrary geometry target and detector array of FIG. 2;

FIG. 4 illustrates an arbitrary geometry system with a conveyer system to convey objects through a covered tunnel, in accordance with one embodiment of the present invention;

FIGS. 5A and 5B illustrate portions of an x-ray generation system using dual and opposing electron beam generators, in accordance with various embodiments of the present invention;

FIG. 6 illustrates an electron beam generator, in accordance with one embodiment of the present invention;

FIG. 7 is a sketch of a portion of an X-ray inspection system using different numbers of detectors sensitive to different energy levels;

FIG. 8 is a schematic illustration of operation of a system with a detector configuration as illustrated in FIG. 7 during a first phase of inspection;

FIG. 9 is a sketch illustrating operation of a system with a detector configuration as illustrated in FIG. 7 during a second phase of operation;

FIG. 10A is a sketch of a volumetric inspection system employing a rotating gantry configured with different numbers of detectors sensitive to X-ray radiation of different energy levels;

FIG. 10B is an enlarged view of a portion of the system illustrated in FIG. 10A; and

FIGS. 11A, 11B, and 11C are sketches illustrating operation of the system of FIG. 10A.

FIG. 12 is a sketch illustrating a linear array of interleaved detectors sensitive to radiation of different energy levels;

FIG. 13 is a sketch indicating an exemplary method of estimating the attenuation of X-ray radiation at two different energy levels in a linear array of interleaved detectors sensitive to radiation of two different energy levels;

FIG. 14 is a sketch illustrating a configuration of a two-dimensional array of interleaved detectors that is sensitive to radiation of different energy levels;

FIG. 15 is a sketch illustrating a source illuminating a skewed array of interleaved detectors; and

FIG. 16 is a sketch of a volumetric inspection system employing a rotating gantry configured with a two-dimensional array of detectors that are sensitive to X-ray radiation of different energy levels.

### DETAILED DESCRIPTION

The inventors have recognized and appreciated that a cost effective, yet accurate, dual energy, volumetric inspection system may be implemented by selectively placing filter elements adjacent an array of detectors. The detectors in the array may be of a single type, and may be a part of a regular array of substantially uniform detectors. In some embodiments, the array of detectors may be commercially available or assembled from commercially available detector components, leading to a low cost implementation.

A sub-set, containing a relatively small number of detectors in the array, may be converted to detectors sensitive to a different energy through selective placement of filter elements. In some embodiments, the filter elements may be implemented using a film, foil or other coating selectively applied to detectors in the subset.

The filtered detectors may be used to gather data that is resampled onto the spatial locations of the detectors that are not filtered. In some embodiments, the resampling may be performed by interpolation or by filtering. Similarly, the detectors that are not filtered may be used to gather data that is resampled onto the spatial locations of the filtered detectors. Measurements at the filtered, and non-filtered, detectors may represent measurements are two different energies, and performing the above pairs of data gathering and resampling operations may allow for the synthesis of a dual-energy reading. Such a dual-energy reading may have almost the spatial resolution that would be obtained from two full sets of detectors, i.e., full sets that can gather data at each of the two different energies at all detector locations.

The detectors in the array that are not filtered may be used to gather data that can be used to construct a volumetric image of an item under inspection. This data may represent attenuation at a first energy. The volumetric image may then be analyzed to detect regions of interest. The source may be positioned such that radiation from the source passes through a region of interest to a filtered detector element. Measurements at the filtered detector elements may represent measurements at a second energy and may be used to compute atomic number information about a region of interest. In this way, dual energy information may be generated using a single array.

Applying filtering elements has the effect of removing a subset of the detectors from the array. Accordingly, some data that might otherwise be used to form the volumetric image is no longer available. Limiting the data used in forming a volumetric image can lead to image artifacts that degrade the quality of the image. However, in some embodiments, image artifacts are avoided, or significantly reduced, through the use of a computational technique to generate data representative of measurements that might have been available were the filter elements not in place.

The inventors have further recognized and appreciated that, though such construction techniques result in non-contiguous detectors sensitive to the same energy level, high spatial resolution at that energy may be achieved using interpolation techniques. Interpolation techniques may be used, for example, to compute values approximating measurements at that energy level at gaps between the non-contiguous detectors. These interpolation techniques may use measurements at one or more energies to approximate values between non-contiguous detectors sensitive to the same energy.

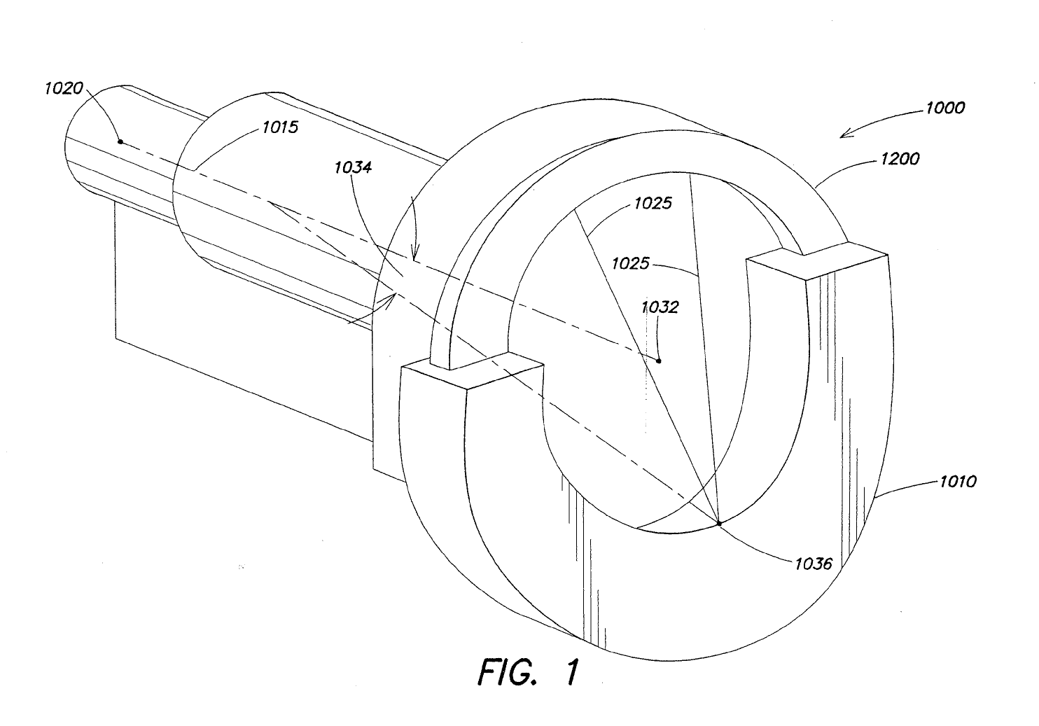

Such a detector configuration may be used in connection with an inspection system architecture of any suitable type. FIG. 1 illustrates schematically an X-ray inspection system employing e-beam technology in a circular geometry in which such a detector array may be applied. Though, it should be appreciated that techniques as described herein may be used in connection with rotating CT systems, multiview projection systems or other systems in which data, representing interaction between radiation and an item under inspection may be controlled to select a path through the item along which that data is collected.

In the example illustrated, x-ray inspection system 1000 includes an essentially circular target 1010 that responds to an impinging e-beam 1015 by emitting X-rays 1025 and an essentially circular array 1200 of detectors responsive to the radiation.

E-beam 1015 emanates from an e-beam point of origin 1020, for example, from an electron gun and is directed essentially along a longitudinal axis that penetrates a center point 1032 of the detector array (or target). One or more magnetic coils (not shown) deflect the e-beam from the longitudinal axis at a deflection angle 1034 so that the e-beam impinges on target 1010, for example, at location 1036 on the target. The resulting X-rays then penetrate an inspection region and impinge on the detector array. The X-ray generation subsystem may then be rotated in a number of ways such that the e-beam impinges at different locations on the target to form a scanning path along the target. As the e-beam is directed along a circular arc of the target, the resulting X-rays penetrate the inspection regions at different angles to provide different projections or views of an object positioned within the inspection region. Other circular geometry systems and methods related to e-beam scanning are described in U.S. Pat. No. 5,491,734 ('734) to Boyd et al., U.S. Pat. No. 4,352,021 ('021) to Boyd et al., and U.S. Pat. No. 6,735,271 ('271) to Rand et al., all of which are incorporated herein by reference in their entirety.

It should be appreciated that FIG. 1 is a conceptual representation of a e-beam system in which a source of x-rays may be controlled. FIG. 1 shows the geometry of the e-beam system is circular. Non-circular geometries may be used. For example, techniques as described herein may be applied in arbitrary geometry systems to facilitate relatively inexpensive, compact and efficient X-ray detections systems. Detector arrays for dual energy measurements formed by selective positioning of filter elements may be used with these arbitrary geometry systems, too. Though, it should be appreciated that the specific geometry of the system is not critical to the invention. For example, a scanning path of an e-beam may traverse a substantially rectangular U-shaped target formed from three substantially linear segments connected by curved segments.

In some embodiments, the plurality of segments are provided continuously. In other embodiments, at least one of the plurality of segments is discontinuous with at least one other segment. For example, each segment may be offset in a direction parallel to the direction of conveyance of an item being inspected by the X-ray generation subsystem.

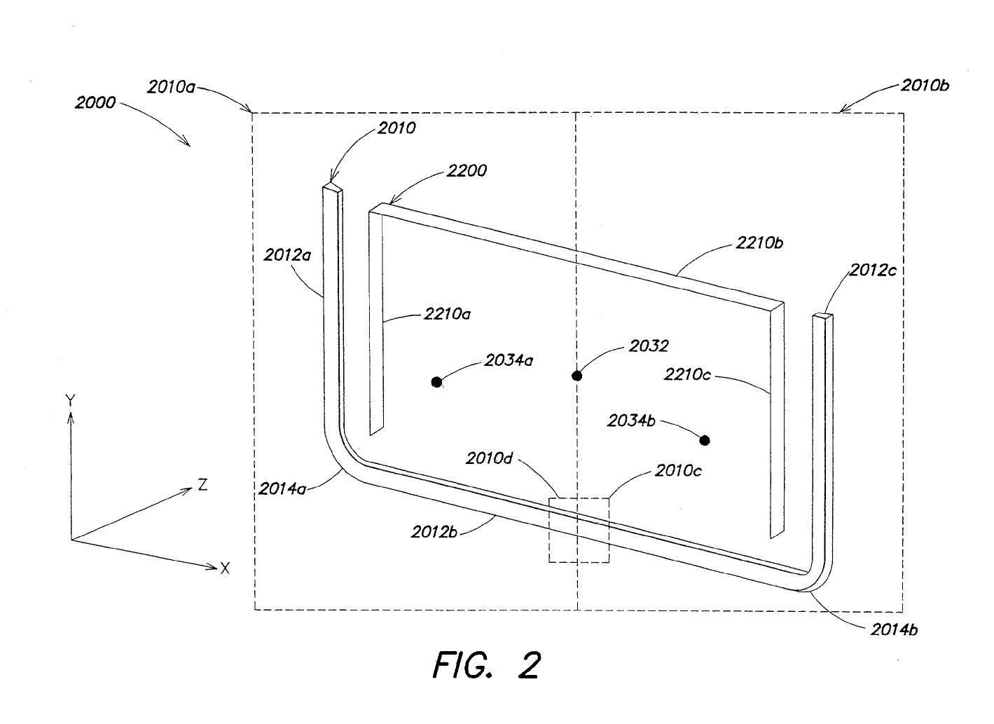

FIG. 2 illustrates portions of an exemplary X-ray generation subsystem, in accordance with some embodiments of the present invention. X-ray generation subsystem 2000 includes a non-circular detector array 2200. In particular, detector array 2200 is generally shaped as a rectangular U, sometimes referred to as goal posts, or staple-shaped, comprising substantially linear segments 2210a, 2210b and 2210c. The U-shaped geometry is merely exemplary of an arbitrary geometry array, which as the name suggests, may take on any shape, as the aspects of the invention are not limited in this respect. The various segments of the detector array may be continuous or they may be staggered, for example, along the z-axis. To irradiate the detector array 2200, a target 2010 that generally mimics the shape of detector array 2200 may be positioned concentrically and diametrically from the detector array and operates as the e-beam anode.

The term “diametric” refers herein to positioning of a target and detector array in an opposing arrangement such that diametric portions of the detector array and target are generally facing one another such that x-rays emitted from the portions of the target impinge on the diametrically arranged portions of the detector array. Target 2010 includes substantially linear segments 2012a, 2012b, and 2012c and circular arc segments 2014a and 2014b. Accordingly, linear segment 2210c of the detector array is arranged diametrically to linear segment 2012a because the x-ray sensitive regions of the detectors on segment 2210c are facing target segment 2012a. Similarly, segments 2010b and 2010c of the detector array are arranged diametrically to circular segment 2014a of the target. As discussed above, target 2010 may be formed from any material that converts energy from an impinging e-beam into X-rays, such as tungsten, molybdenum, etc.

To minimize the deflection angle without unduly compromising the size of the inspection area, multiple e-beam generators, also referred to as electron guns, may be used. In addition, if the required deflection angle may be reduced for a given size target, then, rather than reducing the deflection angle, the same actual deflection angle may be used and the distance between the steering coils and the target may be reduced, as discussed in further detail below. This reduction in distance allows the vacuum tubes through which the e-beams travel after leaving the steering coils to be made smaller, substantially reducing both the cost and bulk of the resulting generation subsystem.

For example, a first electron gun may be deployed to scan portion 2010a of target 2010 and a second electron gun may be deployed to scan portion 2010b. In one embodiment, each electron gun scans substantially half of the target, and in a sequential fashion. By positioning the electron gun pair to scan substantially half of the array, the deflection angles for each gun may be reduced. For example, the electron guns may be positioned such that the e-beam would impinge somewhere along the respective target in the absence of deflection forces, rather than passing through, for example, a center point of the inspection region.

Alternatively, the electron beams, in the absence of deflection forces, may pass through points closer to respective portions of the target, rather than passing through the center point, or other points generally equidistant from various points along the target. For example, rather than having a single electron gun positioned such that the generated e-beam, in the absence of deflection forces, passes through a center points 2032 (as shown in FIG. 2), a pair of electron guns may be positioned such that their e-beams, in the absence of deflection forces, pass through points 2034a and 2034b, respectively. Multiple e-beam generators may be used in numerous configurations to reduce the required deflection angle and/or reduce vacuum tube sizes, as discussed in further detail below.

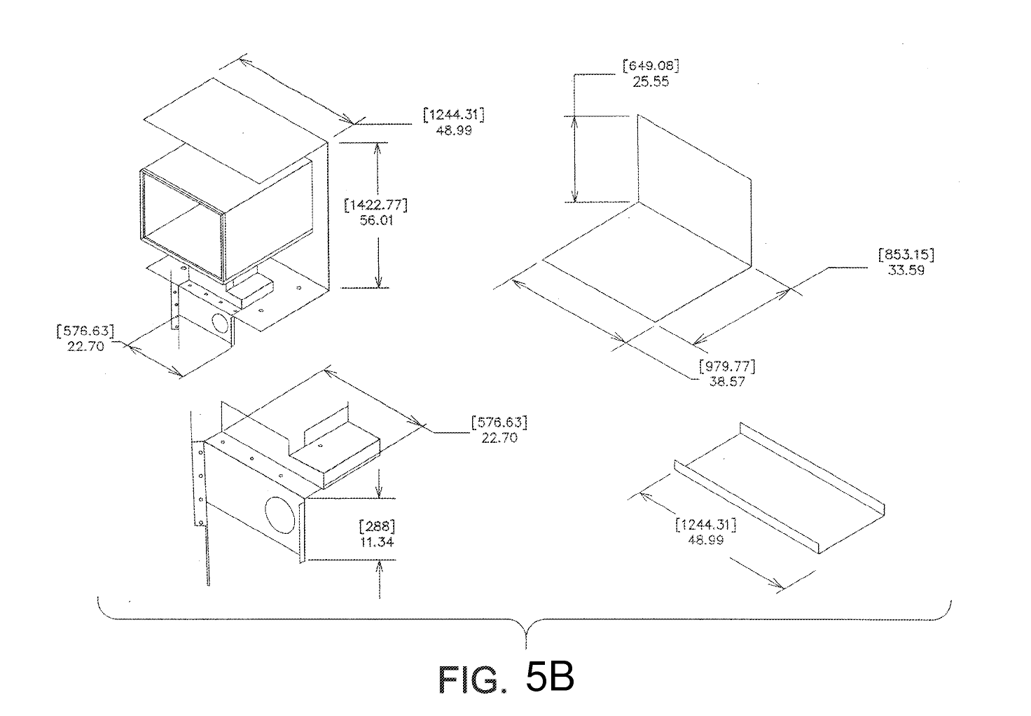

FIG. 6 illustrates an e-beam generator adapted to sweep an e-beam along a target to generate X-rays used to inspect objects of interest. The e-beam generator includes an electron accelerator 2952 adapted to accelerate electrons to an appropriate velocity to create an electron beam suitable for impinging on the target. Various electron/particle accelerators are well known in the art. As described in more detail below, electrons may be accelerated towards target 2910 by application of a voltage between the e-beam generator and target 2910. The level of that voltage may be varied to control the energy levels of X-rays emitted. It should be understood that other acceleration mechanisms that provide a means for varying the acceleration may be used instead of such voltage control.

After the electrons have been suitably accelerated, the electrons may be directed into dynamic steering/focusing mechanism 2954, referred to hereinafter as the steering mechanism. The steering mechanism is configured to bend the path of the electron beam (e.g., using magnetic steering coils) such that the electron beam impinges on target 2910 along a desired scanning path (e.g., from top to bottom of the target). The steering mechanism may also implement focusing components to focus the electrons into a generally desirable shaped beam having a suitable focal point. The electron accelerator and the steering mechanism is collectively referred to as the e-beam generator 2950 or electron gun, which, unless specifically stated otherwise are synonymous terms.

After the e-beam exits the steering mechanism through the exit port 2956, the e-beam propagates through vacuum tube 2960 to impinge on target 2910. Vacuum tube 2960 is generally a relatively expensive and bulky component. The larger the vacuum tube, the more expensive and bulky the x-ray generation subsystem becomes. The size of the vacuum tube is related to the distance between the exit port and the target, which is in turn related to the necessary deflection angle. By using multiple e-beam generators, the distance between the steering mechanism (e.g., the distal end of the e-beam generator) and the target may be reduced, thus reducing the size of the vacuum tube, facilitating a less expensive x-ray generation subsystem having a smaller footprint. However, the number of e-beam generators is not critical to the invention.

If multiple e-beam generators are used, each may be arranged to scan substantially half of a target. In another embodiment, each electron gun scans more than half of the target. For example, it may be desirable for the path of the electrons guns to overlap in a region that includes the seam between the portions of the target that the electrons are respectively responsible for scanning. To achieve the overlap, in the embodiment illustrated in FIG. 2, the first electron gun may provide an e-beam along a path to scan portion 2010a and a relatively small region 2010c extending into portion 2010b. Similarly, the second electron gun may provide an e-beam along a path to scan portion 2010b and a relatively small region 2010d extending into portion 2010a. Information obtained from the resultant overlap region in the two scan paths allows for interpolation so that attenuation values are relatively smooth across the transition point in the paths of the respective electrons guns. However, an overlap region need not be employed, as the aspects of the invention are not limited in this respect.

In some embodiments, a pair of electron guns is housed in a single vacuum tube and is positioned and oriented to scan respective portions of the target via the same vacuum tube. In alternative embodiments, each of a pair of electron guns is housed in respective and independent vacuum tubes, disposed to scan respective portions of the target. Other electron gun/vacuum tube arrangements may be used, as the aspects of the invention are not limited in this respect. Targets of any arbitrary geometry may be used. In FIG. 2, the various segments that form the target are provided continuously. However, in some embodiments, each of the segments is provided at an offset with respect to one another. For example, the linear segment 2012a may be provided at a first depth z₀, the circular segment 2014a may be provided at a second depth z₁, the linear segment 2012b may be provided at a third depth z₂, the circular segment 2014b may be provided at a fourth depth z₃, and the linear segment 2012c may be provided at a fifth depth z₄, wherein the depths zᵢ increase in the direction of an item being conveyed through the generation subsystem. Any one or combination of segments may be offset from the other segments. Likewise, any one or combination of the segments of the detector array may be staggered in the direction of conveyance, or otherwise staggered or offset, as the aspects of the invention are limited in this respect.

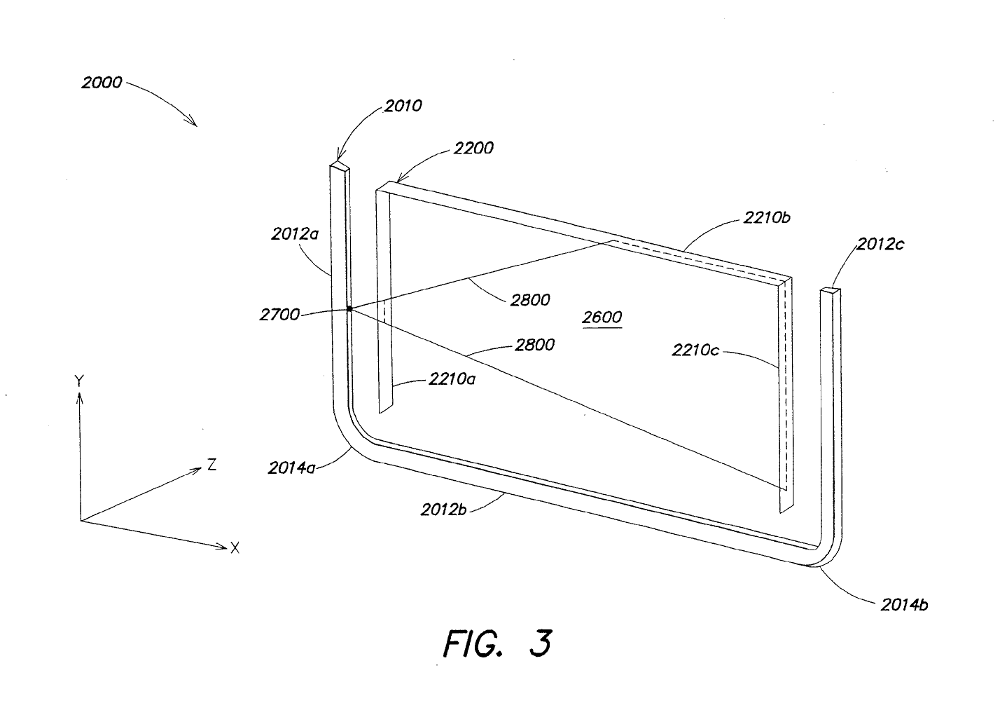

Referencing FIG. 3 (illustrating substantially the same system as FIG. 2), to scan an object positioned in examination region 2600, an e-beam is directed to impinge on target 2010, which responds by emitting X-rays in the 4π directions. The emitted X-rays are then typically shaped by a desired configuration of one or more collimators to form a fan beam, a pencil beam or other shaped beam that enters the inspection region to penetrate an object being scanned, and to subsequently impinge on the diametrically opposed detectors after exiting the object, thus recording information about the interaction of the X-ray beam with the object.

In FIG. 3, collimators (not shown) are arranged such that at each point along the target, emitted X-rays are absorbed except for a fan of X-rays substantially in a plane that is permitted to pass into the inspection region. The fan beam enters the inspection region 2600 and penetrates the object being scanned. The detectors in detector array 2200 respond to X-rays generated from a diametric portion of the target. For example, the detectors along arms 2210b and 2210c of the detector array 2200 detect X-rays in the fan beam generated along arm 2012a of the target, as illustrated by exemplary fan beam 2800 emitted by X-ray source location 2700. As a result, when the detector array is substantially aligned in the same plane as the target, fan beam 2800 passes through the near side of the detector array (e.g., arm 2210a of the detector array) before entering the inspection region and ultimately impinging on the portion of the detector array intended to record attenuation information (i.e., the far side detectors). It should be appreciated that in the embodiment of FIG. 3, the source location 2700 may be controlled by steering an electron beam directed at the target.

Regardless of the specific target configuration, an x-ray generation subsystem with a steerable source location may be used to construct an x-ray scanning device.

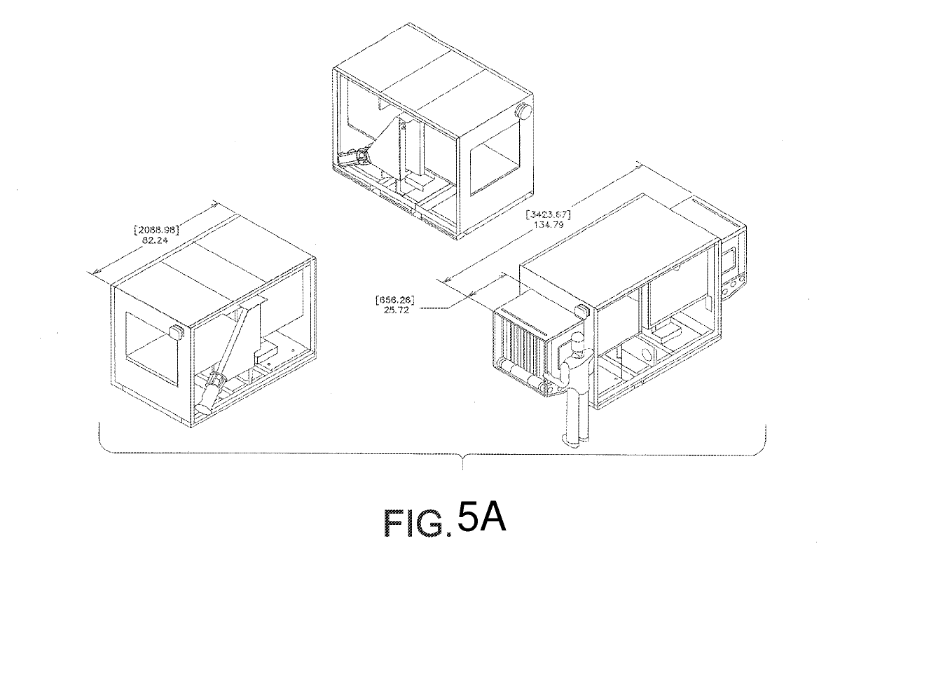

FIGS. 5A and 5B illustrate one embodiment of an x-ray scanning device adapted to inspect object of interest placed on a conveyer mechanism that transports the object though a substantially enclosed housing. Such an x-ray scanning devices may be constructed in any way, as the aspects of the present invention are not limited to any particular type of construction, implementation or arrangement of parts.

An e-beam may be sequentially directed along a target to produce X-rays at varying angles about an object being scanned. By moving the point at which the e-beam impinges on the target, a number of views of the object at different angles may be obtained. The detector signals generated in response to impinging X-ray radiation over different viewing angles (e.g., over 180°) may be back-projected or otherwise processed to form a computer tomography (CT) image (or, in some cases, a laminographic image). That is, X-ray data represented as a function of detector location (t) (e.g., distance from the center of the reconstruction) and view angle θ, referred to as view data, may be transformed into image data representing, for example, density as a function of space.

The process of transforming view data into image data is referred to as image reconstruction and numerous methods of performing the transformation are known in the art. Back-projection, for example, is a well-known image reconstruction algorithm. In back-projection, the view data in a (t, θ) coordinate frame is mapped into object or image space in a (x, y) coordinate frame. That is, each location in (x, y) space is assigned an intensity value based on attenuation information contained in the view data. As a general matter, image reconstruction is less complicated when the angle formed between successive locations at which the e-beam impinges on the target (i.e., successive X-ray source locations) and a center point of the inspection region are equidistant.

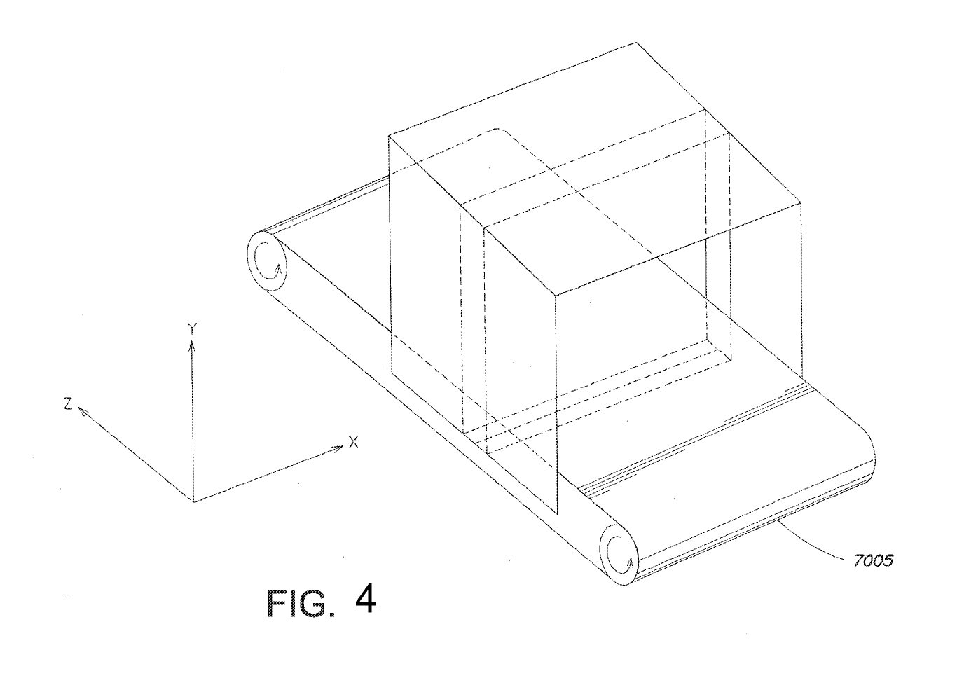

In many X-ray generation subsystems, such as X-ray detection systems adapted for scanning items such as articles of baggage, parcels, or other containers, where it is desired to perform an inspection of the item for prohibited material, the items being inspected may be conveyed through an inspection region on a conveyor. For example, FIG. 4 illustrates an X-ray detection system where items for inspection are carried through a detection area on a conveyor 7005 in a direction parallel to the z-axis. FIGS. 5A and 5B illustrate other embodiments of X-ray detection systems wherein items to be inspected are conveyed through a tunnel to be exposed to X-ray radiation. Synchronizing of the scan and the position of the conveyer facilitates pipelining the reconstruction into a regular grid of voxel dimensions.

It should be appreciated that an X-ray generation subsystem may include more than one target and/or detector array. For example, in some embodiments, multiple detector arrays are disposed successively in the direction of motion of an item being inspected. One or more targets may be positioned to generate X-rays to impinge on the multiple detector arrays. In one embodiment, each detector array has a respective target positioned to generate X-rays to impinge on the detector array. Any configuration and combination of target and detector array may be used, as the aspects of the invention are not limited in this respect.

The foregoing, and other suitable systems, may be adapted to perform dual energy measurements. In some embodiments, dual energy measurements are performed by measuring attenuation at two or more energy levels. In some embodiments, a higher energy level may be selected so as to create Compton scattering and a lower energy level may be selected to provide photoelectron scattering. Though, any suitable energies may be used, such as between 120-130 keV for higher energy radiation and between 50-120 keV for a lower energy radiation. One approach for performing dual energy imaging is to use at least two types of detectors, with detectors in each set sensitive to different energy levels.

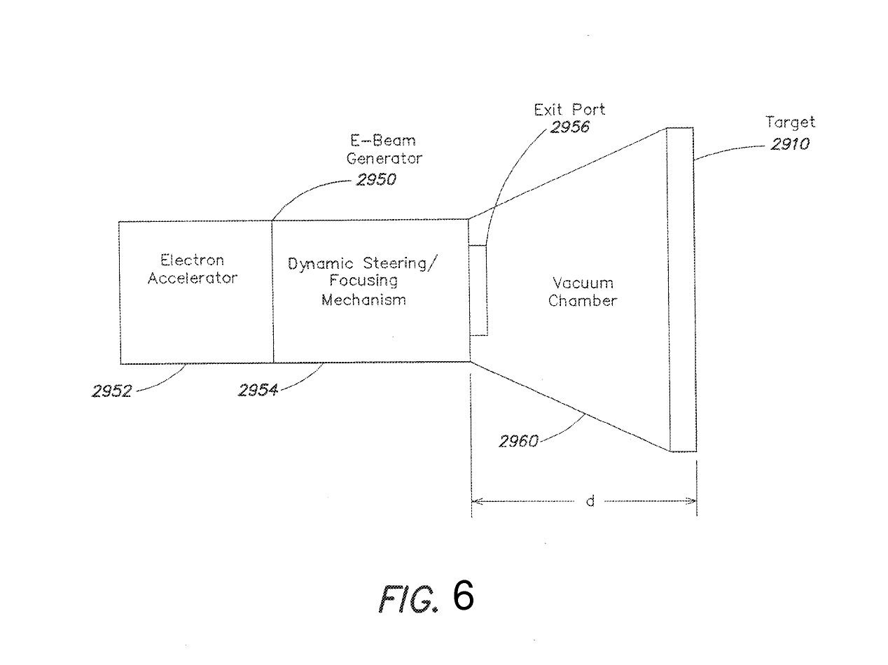

The cost of two sets of detectors, one to detect low energy X-rays and one to detect high energy X-rays, has been a drawback of using dual energy measurement techniques. FIG. 7 illustrates a system configuration that takes advantage of an ability to control the point of origination of X-ray radiation that exists in most inspection systems that form volumetric images. The system illustrated avoids the need for two full sets of detectors in order to make dual energy measurements. Such a configuration may be useful in a security inspection system configured to identify objects that may constitute threats, such as weapons, explosives or other contraband, within items under inspection. In some embodiments, dual energy measurements may be made with a single array of like detectors through the selective placement of filter elements.

Such systems may operate by processing a volumetric image to identify objects based on density or other characteristics. Analysis then may be performed on the identified objects to determine characteristics that may be indicative of threat or non-threat objects. Atomic number, which may be inferred from dual energy X-ray measurements, is one such characteristic. FIG. 7 illustrates a low cost system configuration that can provide information useful in performing such a threat assessment.

FIG. 7 illustrates a portion of an inspection system. The portion shown is a corner surrounding a tunnel 3500, through which items under inspection may pass.

FIG. 7 shows that the tunnel 3500 is lined with X-ray detectors sensitive to X-ray radiation. In the embodiment of FIG. 7, detector segments 3510₁, 3510₂, 3510₃ and 3520₁ are such X-ray detectors.

FIG. 7 shows only a portion of tunnel 3500. Accordingly, only a portion of the X-ray detectors that may exist in an inspection system are illustrated. The X-ray detectors may be positioned around tunnel 3500 in a U-shape or a staple-shape which is illustrated in conjunction with FIG. 2 above. The x-ray detectors, for example, may be positioned in a linear array with substantially uniform spacing between detector elements. However, the specific configuration of radiation detectors is not critical to the invention as any suitable configuration may be used.

Regardless of the configuration of high-energy X-ray detectors, the inspection system illustrated in FIG. 7 may include filter elements that convert a subset of the detectors into energy detectors sensitive to X-rays of a second energy range. The filter elements may be implemented, for example, as a foil or other coating over some of the detector elements in the array. In the portion of the detector array illustrated in FIG. 7, one such detector element, detector 3520₁ is converted in this way. Though, it should be appreciated that in a full detector array, more than one such detector element may be converted.

In the example of FIG. 7, detector 3520₁ is illustrated as having a coating covering the detector surface such that the detector is sensitive to X-rays of a second energy range. The coating may cover some or all of the detector surface, and may have a thickness depending on the desired attenuation effect. The coating may also be composed of any suitable material that can be applied to the detector surface. As a specific example, the coating may be a layer of silver or other metal.

As can be seen, detector 3520₁ occupies a portion of the array shared with X-ray detector segments 3510₁, 3510₂ and 3510₃. Though other coated detector segments may be mounted within an X-ray inspection system, the total area occupied by the coated X-ray detectors may be substantially less than the area occupied by non-coated X-ray detectors. In some embodiments, the total area of coated X-ray detectors is 10% or less than the area occupied by non-coated X-ray detectors. As a specific example, the area of coated X-ray detectors may be 1% or less.

In the embodiment illustrated, coated X-ray detector segment 3520₁ is mounted between un-filtered X-ray detector segments 3510₂ and 3510₃. Such a configuration may result in data obtained at the un-filtered detectors that is non-continuous due to X-rays being highly attenuated by a filtered detector. In this example, detector segment 3520₁ creates a gap in the detector array that is being used to measure energy at a first energy.

Such a gap can tend to lead to image artifacts, if conventional volumetric image reconstruction techniques are used on that data. To avoid image artifacts, a value may be computed to represent a measurement in each such gap. Such a computed value may correspond to a value that might be measured at the location of a filtered detector segment.

Any suitable computation technique may be used. In some embodiments, interpolation may be used to compute a value representing a measurement in such a gap. The interpolated value may then be used along with measured values at the first energy to construct an output image. The interpolation may be based solely on values measured at the unfiltered detector segments, which generate values at the first energy. Though, measurements made with the filtered detectors may also be used.

As a specific example, a value corresponding to a location in the array occupied by filtered detector segment 3520₁ may be computed from measured values at adjacent detector segments, such as detector segments 3510₂ and 3510₃. Such a value may be computed using linear interpolation. However, it should be appreciated that any suitable interpolation function may be used and the interpolation function may be based on more than two adjacent detector segments.

The interpolation, or other computation used to generate values representative of radiation at the first energy, impinging on the filtered detector elements may be performed at any suitable time. In some embodiments, each time the un-filtered detectors are read, the computation may be performed. Though, it may be appreciated that it is not a requirement that the computation be performed for every set of detector values read.

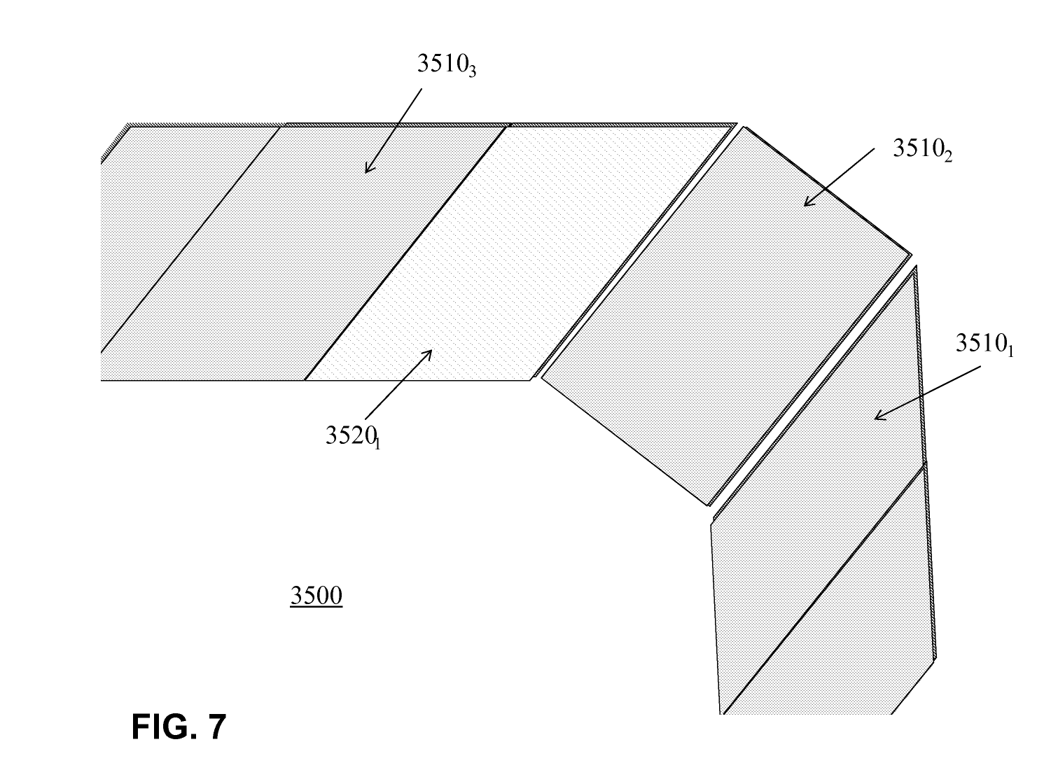

Regardless of the number and positioning of coated and non-coated X-ray detector segments, FIG. 8 illustrates a process by which an inspection machine configured generally as illustrated in FIG. 8 may be operated to perform inspection using dual energy techniques. FIG. 8 illustrates schematically a cross-sectional representation through such an inspection system. An item under inspection 3600 is shown within tunnel 3500. In the illustrated embodiment, unfiltered energy X-ray detector segments 3510₁, 3510₂ . . . 3510₅ are arrayed generally in a U-shape around sides of tunnel 3500.

Targets 3610A and 3610B are also shown. Targets 3610A and 3610B may each form a portion of an X-ray generation subsystem employing a steered electron beam as described above. An electron beam may be steered to multiple scan positions around targets 3610A and 3610B and, at any time during the scan, X-ray radiation will originate from the current scan position.

While the beam is scanned across the targets, the outputs of X-ray detector segments may be captured and processed, such as in processor 3650. As illustrated in FIG. 8, at each scan position, such as scan positions S₁ and S₂, the radiation generated from the targets 3610A and 3610B will travel along multiple rays through item under inspection 3600 to one of the detector segments 3510₁ . . . 3510₅. As a result, the captured outputs of the X-ray detector segments represent measurements taken from multiple points of view, allowing processor 3650 to compute a volumetric image of item under inspection 3600 as it passes through tunnel 3500 past the X-ray detectors.

In embodiments in which X-ray detector segments 3510₁ . . . 3510₅ are sensitive to radiation of a particular energy, the formed volumetric image will be a single energy image. Though termed “single energy,” it should be appreciated that such an image may be formed with X-rays having a spectrum of energies. In this case, the image is single energy because the detectors used to form the image are exposed to substantially the same spectrum and respond in substantially the same way to that spectrum. It may, for example, contain information about density of objects within item under inspection 3600. However, as a single energy measurement, it will not contain information about atomic number of the materials inside item under inspection 3600. Nonetheless, known single energy volumetric image analysis techniques are capable of identifying boundaries of objects.

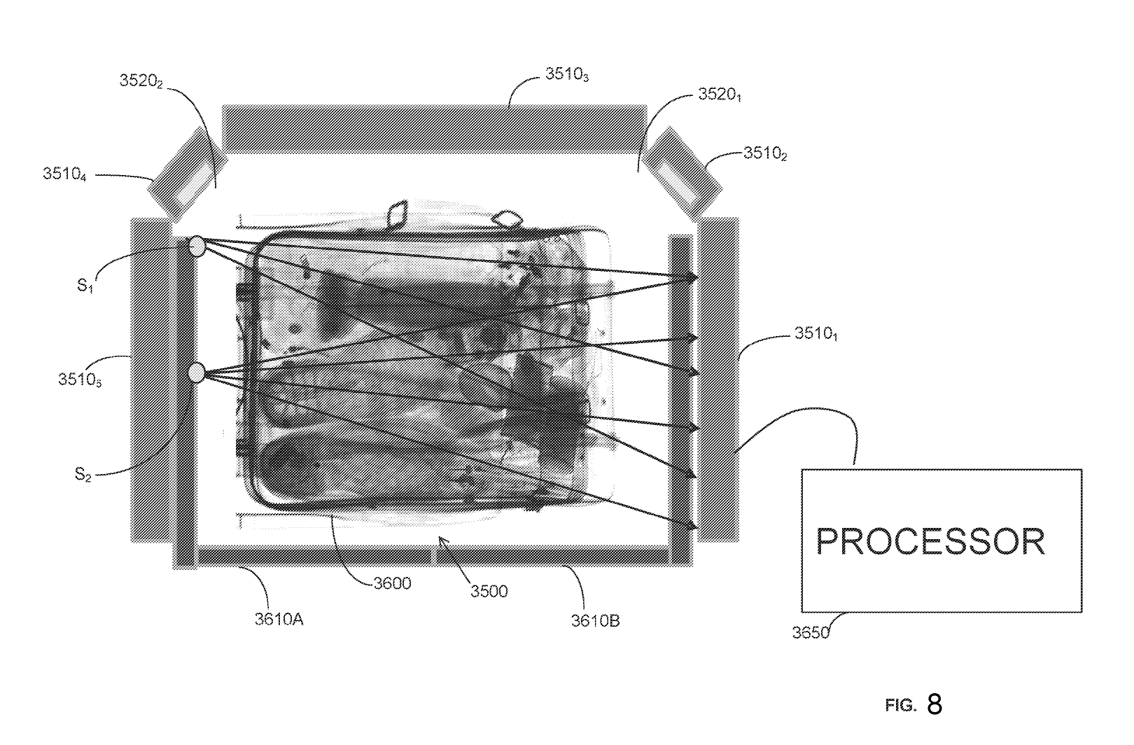

Turning to FIG. 9, a result of the single energy volumetric image is schematically depicted. In the example of FIG. 9, analysis of a single energy volumetric image has resulted in the identification of objects of sufficient density that they are potentially threat objects within item under inspection 3600. For exemplary purposes, FIG. 9 illustrates three such objects identified, objects 3710₁, 3710₂ and 3710₃. In addition to identifying that such objects are present, processing within processor 3650 (FIG. 7) has determined the location within tunnel 3500 of those objects.

Other objects may be present within item under inspection 3600, such objects may be of such low density as to have an insignificant impact on X-rays passing through item under inspection 3600. In the example of a security inspection system, a suitcase may contain clothes, which are relatively low density, and metal objects and plastic objects, which may be of higher density. FIG. 9 illustrates that the higher density objects have been identified for subsequent processing. In some embodiments, lower density objects may be omitted from subsequent analysis without appreciably affecting the results. Though, other embodiments are possible in which even lower density objects are considered or the nature of background material or other characteristics of item under inspection are incorporated into image processing methods. The specific density or other characteristics of objects regarded to be of interest is not critical to the invention and any suitable characteristics may be used to select objects for further inspection.

Regardless of the number or nature of objects identified for further processing, dual energy processing on the identified objects may be performed by selecting outputs of coated energy detectors at selected times. FIG. 9 illustrates various possible rays from potential scan positions on targets 3610A and 3610B and coated detector segments 3520₁ and 3520₂. During a scan, such rays will extend from each scan position to each coated detector.

In some embodiments, some rays are selected to provide a data at a second energy. In this example, that data may correspond to high energy data. As with the single energy measurement, the measurement at a second energy need not be based on X-rays of a single energy. Rather, some characteristics of the measurement, for example the energy spectrum of the radiation or the responsiveness of the detector, is different than for a measurement at a first energy. In this way the data measured at a first energy and a second energy provides information indicating differences in the way an object through which that radiation has passed interacts with radiation at different energies. These differences, in turn, provide information about the atomic number of the object.

In this example, the measurement made using filtered detector segments 3520₁ and 3520₂ may be high energy measurements. Though all of the detector segments may be exposed to X-rays with substantially the same energy spectrum and all may have substantially the same base construction and response to those X-rays, the coating over some segments may block lower energy radiation from reaching those detectors. As a result, the outputs of the un-coated detectors may be more influenced by low energy X-rays than the coated detectors such that the coated detectors may provide higher energy measurements usable for dual energy analysis.

The selected rays are those that pass through locations within item under inspection 3600 that contain objects identified for further analysis without passing through other objects that significantly alter radiation passing through item under inspection 3600. In this way, the radiation measured at the detectors provides a reliable indication of the interaction between X-rays and a particular one of the identified objects. This information in combination with the information at the first energy used to made the volumetric image, is adequate to perform dual energy analysis that indicates an atomic number of the object.

For example, FIG. 9 indicates that when an electron beam is focused in scan position S₄, ray R₁ passes through object 3710₁ and reaches low energy X-ray detector 3520₂ without interacting significantly with any other objects within item under inspection 3600. Similarly, when an electron beam is focused on scan position S₆, ray R₂ passes through object 3710₂ without interacting with other objects. Similarly, when an electron beam is focused on scan location S₅, ray R₃ passes through object 3710₃ on its way to coated X-ray detector segment 3520₁ without interacting with other objects. Accordingly, by selecting the output of the coated detectors when an electron beam is in scan locations S₄, S₅ and S₆ data at a second energy may be obtained, allowing processor 3650 to compute the atomic number of objects 3710₁, 3710₂ and 3710₃. Based on this computation, processor 3650 may more reliably determine whether any of objects 3710₁, 3710₂ or 3710₃ within the item under inspection constitutes a threat.

Conversely, ray R₄ is shown passing through multiple objects, here objects 3710₁, 3710₂. Accordingly, when an electron beam is focused on scan location S₃, the data recorded at coated detector segment 3520₁ reflects a combination of the effects of objects 3710₁ and 3710₂. While such a measurement may provide information about both objects 3710₁ and 3710₂, it is not directly useful in determining the atomic number of either objects 3710₁, 3710₂ as would be the information obtained for measurements based on rays R₁ or R₂.

Accordingly, processor 3650 may be operated according to a method in which scan locations for performing X-ray measurements at a second energy are identified and prioritized, with scan locations providing paths through isolated objects being preferentially selected. When an item under inspection contains too many objects or the objects are positioned in such a fashion that no scan position allows some objects to be isolated, rays that are the least subject to interference as a result of passing through multiple objects are next selected or alternative processing approaches may be taken to analyze the content of the item under inspection.

It should be appreciated that FIG. 9 schematically illustrates a processing approach, and the data reflected in that figure may be collected in any suitable way. For example, it is not a requirement that the scan locations, S₄, S₅ and S₆ be identified prior to the time at which detector outputs are captured. As an example of one possible implementation, the inspection system illustrated in FIG. 9 could be operated to perform a single scan around targets 3610A and 3610B during which detector outputs of both non-coated detector segments and coated detector segments may be captured. Once processor 3650 completes processing on the outputs of the non-coated detector segments, it may identify outputs of the coated detector segments 3520₁ and 3520₂ at times that correspond to rays of interest through the item under inspection 3600. However, the measurements may be collected at any suitable times in any suitable order.

In the example embodiment of FIG. 7, both the non-coated detector segments and the coated detector segments extend a noticeable amount in a direction aligned with the axial dimension of tunnel 3500. The amount by which the detector segments extend in this axial dimension may depend on the speed at which items move through the tunnel relative to the time it takes to complete a scan.

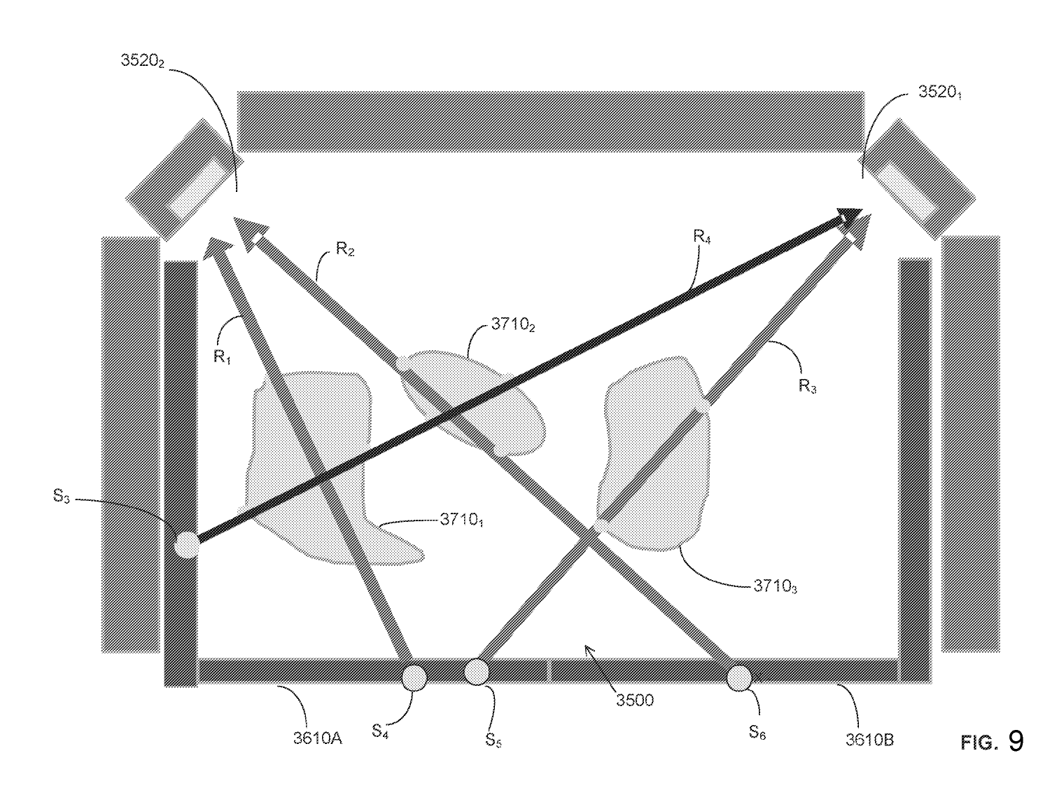

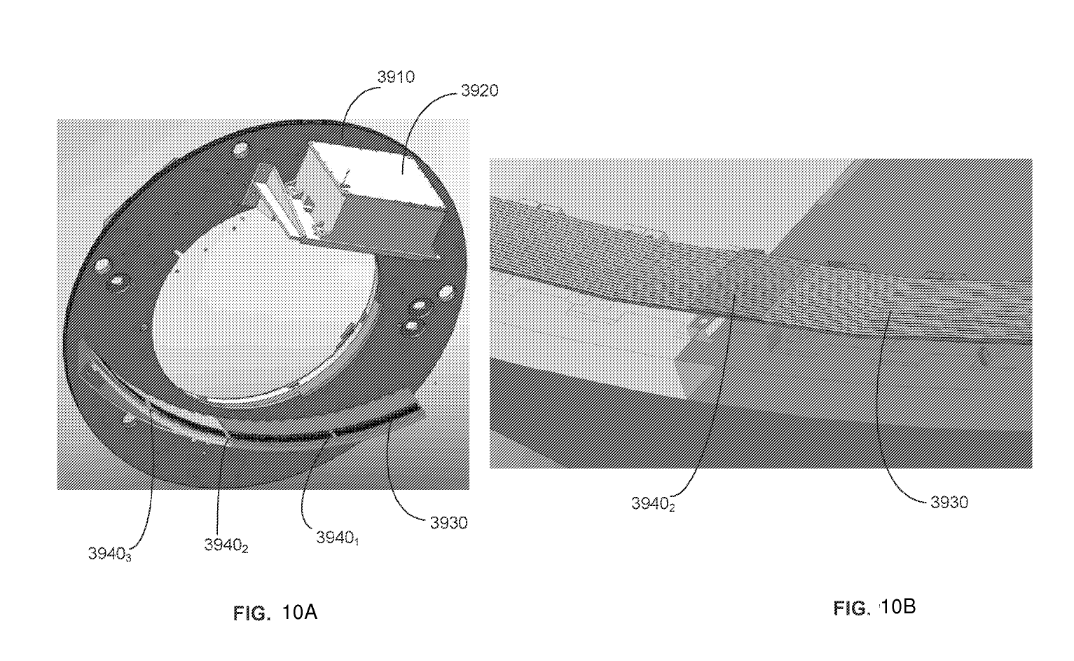

FIGS. 7, 8 and 9 illustrate a dual energy measurement technique using a relatively small number of detector segments sensitive to X-rays of a second energy. In that embodiment, rays of radiation passing through an item under inspection are selected based on a point of origin of the radiation relative to the low energy detector segments and objects in the item under inspection. In that embodiment, steering an electron beam to various scan locations on a target is used to provide radiation originating from different locations at different times such that the detector outputs attributable to specific rays can be selected. It is not a requirement of the invention that radiation originating from multiple points be provided by scanning an electron beam across a target. FIGS. 10A and 10B illustrate an alternative embodiment.

In the embodiment of FIGS. 10A and 10B, mechanical motion of the source relative to the item under inspection is used to generate rays having different points of origin at different times. Accordingly, FIG. 10A shows an X-ray source 3920 mounted on a gantry 3910. Gantry 3910 and source 3920 may be components as are known in the art in a mechanical CT system.

FIG. 10A similarly shows that gantry 3910 includes an opening through which items under inspection may pass. On the opposite side of this opening from source 3920 is a detector array 3930. Detector array 3930 may be mounted to gantry 3910 as in a conventional CT system. In this embodiment, detector array 3930 may comprise detectors that are sensitive to X-rays with energies in a spectrum spanning multiple energies, similar to detector array segments 3510₁ . . . 3510₅ (FIG. 8).

As with the embodiment illustrated in FIG. 7, a coating, such as a metal foil, 3940₁ . . . 3940₃ may be overlaid on a small percentage of the detectors in detector array 3930. FIG. 10B shows an enlarged view of a portion of detector array 3930 overlaid with a coating 3940₂. Accordingly, a system incorporating the gantry as illustrated in FIG. 10A may collect, as in a conventional CT system, measurements at a first energy sufficient to compute a volumetric image of an item under inspection. Outputs of the coated detectors may not be used in this computation. However, omitting those values may leave spatial “gaps” in the data. These gaps may be filled by interpretation or in any other suitable way. Based on this image, objects may be identified and selected ones of the measurements made with the detector segments covered with coating 3840₁ . . . 3840₃ may be identified to provide dual energy information about specific objects.

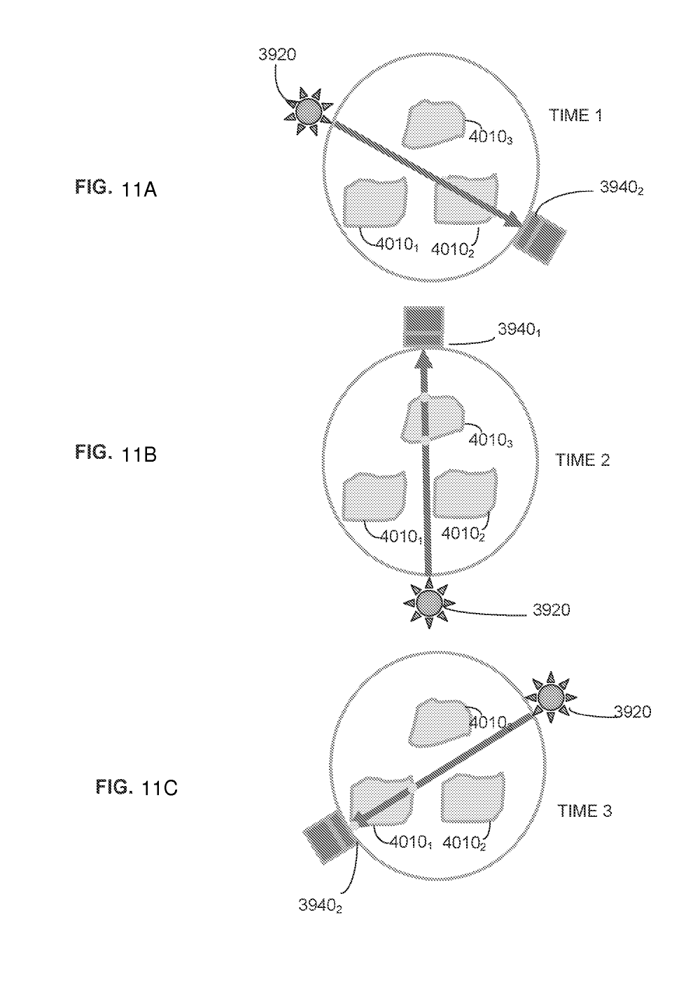

As with the embodiment of FIG. 7, the identified measurements may represent measurements of interactions of X-rays through one or a small number of objects within the item under inspection. FIGS. 11A, 11B and 11C illustrate this approach.

FIG. 11A illustrates that objects 4010₁ . . . 4010₃ have been identified. At some time, denoted in FIG. 11A as TIME 1, a ray passing from source 3920 to a covered detector segment 3940₂ passes through object 4010₂, without being substantially affected by other objects. Accordingly, the output of detector segment 3940₂ at TIME 1 provides information that may be used, in combination with values of a portion of a volumetric image representing object 4010₂, for determining an atomic number of object 4010₂.

FIG. 11B illustrates a position of the gantry at a TIME 2. At this time, the gantry is positioned such that a ray from source 3920 to low energy detector segment 3940₁ passes through object 4010₃ without being substantially impacted by other objects in the item under inspection. Accordingly, the output of the coated detector captured at TIME 2 may provide a useful indication of the atomic number of object 4010₃.

Similarly, FIG. 11C shows a gantry configuration at a TIME 3. With this configuration, a ray from source 3920 to coated detector segment 3940₂ passes through object 4010₁ without being substantially impacted by other objects in the item under inspection. Accordingly, outputs of the coated detector recorded at TIME 3 provides a useful indication of the atomic number of object 4010₁.

As described above, an inspection system may include filter elements that convert a subset of the detectors into energy detectors sensitive to X-rays of a second energy range. The arrangement of detectors having a filter element and detectors not having a filter element may comprise any suitable configuration of detectors and filter. The descriptions below refer to ‘filtered’ and ‘non-filtered’ detectors although, as described above, groups of detectors that sensitive to different energy levels may be created using any suitable techniques and the embodiments described below are not limited to the use of any particular technique.

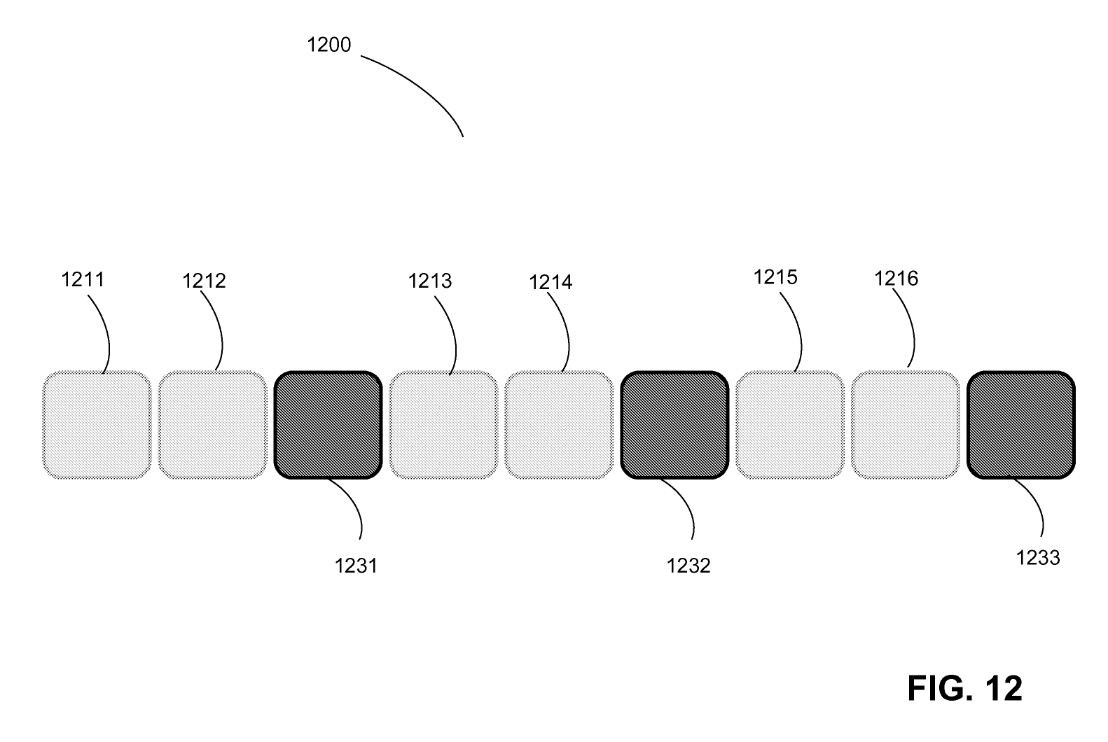

Moreover, though the above embodiments have a relatively low percentage of filtered detectors, other embodiments may have a higher percentage of filtered detectors. FIGS. 12-16 illustrate additional exemplary configurations of detectors sensitive to radiation of different energy levels. Such detectors may be configured in any suitable way, including those described above. FIG. 12 illustrates a linear array of interleaved detectors sensitive to radiation of different energy levels. In FIG. 12, labels 1811-1816 indicate non-filtered detectors, and 1831-1833 indicate filtered detectors.

FIG. 12 depicts a linear array having a regular (i.e., repeating) pattern of detectors of two different types, in a ratio of 2:1. Though there is no requirement that the array have a regular pattern of each detector type or that there be any specific ratio. For example, while the array of detectors may be a repeating pattern (e.g., alternating a first quantity of filtered detectors with a second quantity of non-filtered detectors and repeating this sequence), the array may also be a non-regular or random sequence of filtered and non-filtered detectors. Irrespective of how the filtered and non-filtered detectors are arranged in an array, the spacing between detectors may be any suitable distance, although it may be preferable to minimize the space between detectors to maximize the area in which X-ray radiation may be measured. In some embodiments, the spacing between adjacent detectors is substantially equal to the spacing between all other pairs of adjacent detectors.

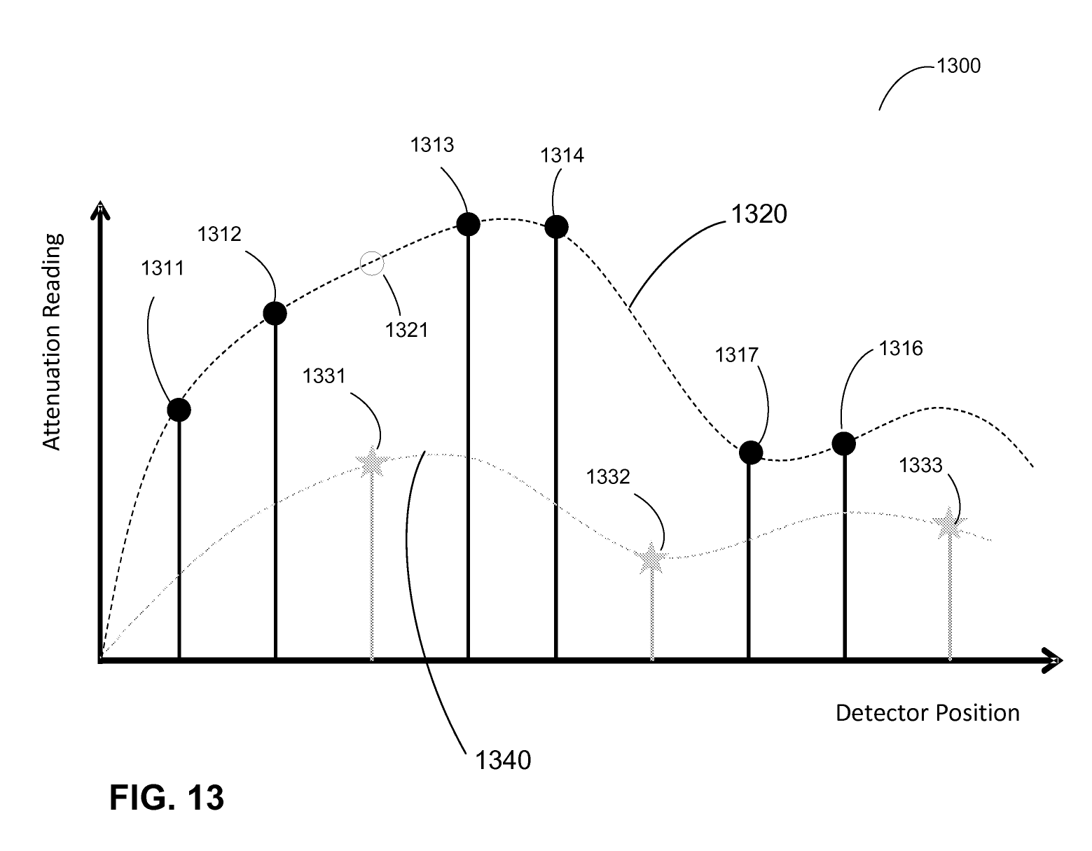

FIG. 13 is a sketch indicating an exemplary method of estimating the attenuation of X-ray radiation in an array of detectors sensitive to radiation of two different energy levels. In the example of FIG. 13, the array shown in FIG. 12 is used to measure the attenuation of X-ray radiation at each detector. In chart 1900, the measured attenuation values are indicated by data points 1911-1916 and 1931-1933. Data points 1911-1916 correspond to data taken by non-filtered detectors 1811-1816, respectively, and data points 1931-1933 correspond to data taken by filtered detectors 1831-1833, respectively.

As described above, the attenuation of X-ray radiation at a particular energy level may be estimated at locations that do not contain detectors sensitive to that energy level. In the example of FIG. 13, estimated attenuation curve 1920 indicates the attenuation as estimated based on the attenuation values of data points 1911-1916. Although detector 1831 is an unfiltered detector, the attenuation of a filtered detector at the same location can be estimated, as shown in FIG. 13 as estimated attenuation data point 1921. Other estimated attenuation values are not shown in the figure, though are implied by the values underlying estimated attenuation 1920. Known mathematical techniques may be applied to estimate attenuation in a gap between adjacent detectors. A first order estimation technique may be used. Alternatively, higher order estimation and/or curve filtering techniques may be used. However the estimation may be performed using any suitable technique, including those described above.

Similarly, estimated attenuation curve 1940 indicates the attenuation as estimated based on the known attenuation values of data points 1931-1933. Although detector 1814, for example, is a filtered detector, the attenuation of an unfiltered detector at the same location has been estimated. Accordingly, the attenuation may be estimated at all locations for two different energy levels.

Moreover, the information obtained by measurements across the full array of detectors, even though those detectors are sensitive to energy at different levels, may be used to compute estimated values at one energy, or both. For example, the estimated values at a first energy, such as estimated value 1921, may be computed based on information at that energy as well as at another energy. For example, in computing estimated value 1921, data points 1911-1914 may be used. Additionally, data point 1931 or other data points at a second energy may be used.

Data points at multiple energies may be used in any suitable way to estimate a data point representing attenuation at a gap between detectors of the same energy. As a specific example, local variations in measurements made at two or more energies may be compared. Local derivatives from data points measured at one energy may be used to augment interpolation between values at another energy.

As a specific and non-limiting example, a slope of estimated attenuation curve 1920 may be estimated to the right of data point 1912 to be the same as the slope between points 1911 and 1912. Similarly, the slope of estimated attenuation curve 1920 may be estimated to the left of data point 1913 to be the same as the slope between points 1913 and 1914. The a slope of estimated attenuation curve 1920 may be estimated around the midpoint between data points 1912 and 1913 to be the same as the slope of estimated attenuation curve 1940 in the vicinity of data point 1931. Accordingly, estimated attenuation curve, 1920 may be pieced together in the region between data points 1912 and 1913 by assembling three segments, with these estimated slopes.

Though, other approaches for using the data at two different frequencies together may be used. For example, a local derivative on estimated curve 1940 may be used as an initial estimate in computing estimated curve 1920 or may be used to adjust a curve computed using a curve fitting algorithm.

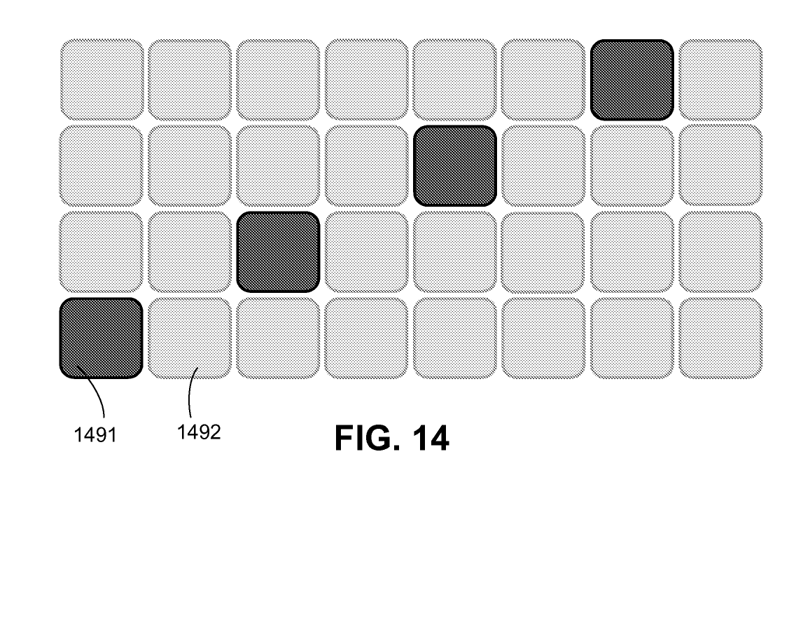

FIG. 14 is a sketch illustrating an exemplary configuration of a two-dimensional array of detectors sensitive to radiation of two different energy levels. In this example, detectors of each type are illustrated by shaded squares. The dark squares indicate detectors sensitive to a first energy level, and the light squares indicate detectors sensitive to a second energy level. For example, in FIG. 14 detectors 1491 indicate detectors sensitive to a first energy level, and detectors 1492 indicate detectors sensitive to a second energy level. FIG. 14depicts an exemplary configuration of detector types wherein the detectors are arranged in a two-dimensional array, although any suitable configuration may be used, including regular (repeating) patterns in addition to detectors placed in a non-repeating or random pattern.

FIG. 14 illustrates a configuration in which the number of detectors sensitive to a first energy level is substantially higher than the number of detectors sensitive to a second energy level. As non-limiting examples, the fraction of detectors sensitive to the second energy level may be substantially lower than 50%, or may be as low as 1% or 10%, in some embodiments. In general, however, any suitable fraction may be used.

In some embodiments, the detectors sensitive to the second energy level are detectors having a filter element adjacent to them, as described above. In this case, the majority of detectors may be of the unfiltered type, the combined effect of which may allow for measurements of low energy X-ray radiation at a high resolution and for measurements of high energy X-ray radiation at a low resolution. Such a configuration may be useful to obtain high resolution information on the density of an object while also obtaining dual energy information. However, the above are provided merely as examples, as any suitable configuration of detectors arranged into a two-dimensional array may be used.

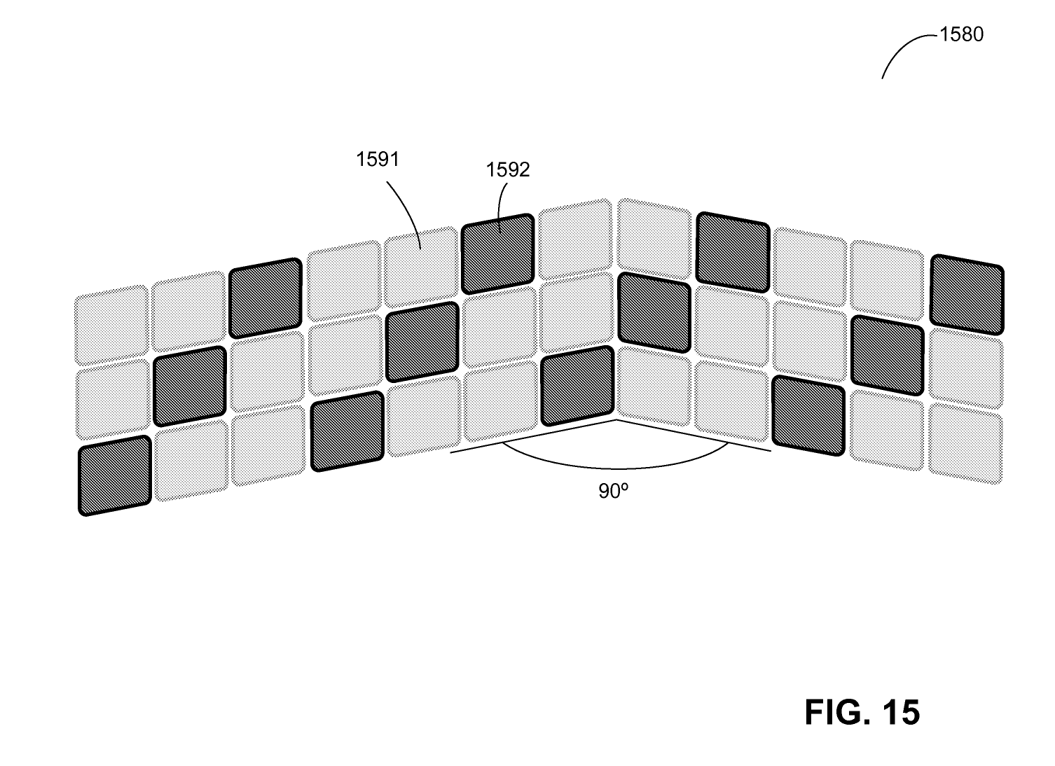

FIG. 15 is a sketch illustrating an array of interleaved detectors, which may be skewed. In a skewed array, an x-ray source may have a target positioned in a first plane. The detectors may be positioned in one or more arrays that are also positioned in a plane, but the plane of the detector array may be skewed with respect to the first plane. Arrays of detectors, such as those described above in connection with FIGS. 12 and 14, may be arranged into a configuration in which the array conforms to a non-linear shape. For example, the detectors may follow a curved path, or may be arranged into a skewed array such as the one shown in FIG. 15. In some embodiments, such as array 2180, a two-dimensional array of detectors sensitive to radiation of two different energy levels are arranged along a pair of lines intersecting at an angle.

In FIG. 15, detectors of each type are illustrated by shaded squares, wherein the dark squares indicate detectors sensitive to a first energy level, and the light squares indicate detectors sensitive to a second energy level. For example, in FIG. 15 detector 2191 indicates a detector sensitive to a first energy level, and detector 2192 indicates a detector sensitive to a second energy level.

A non-linear array, such as the one shown in FIG. 15, may be illuminated by a single source of X-ray radiation, but may also be illuminated by multiple sources of X-ray radiation placed at distinct positions that each illuminate the array (after having first illuminated a sample, as described above) over a period of time. The time-multiplexed information obtained from such a set of sources may thereby be used to improve the resolution of the data estimated at each detector location for each of the two energy levels, based on the measured data at each detector.

In the example of FIG. 15, the detector array is arranged along two lines intersecting at an angle of 90°, although it will be appreciated that detectors could also be arranged along two or more lines intersecting at any angle. For example, detectors may be aligned along a path consisting of two sets of parallel lines which periodically connect (a ‘zigzag’ pattern), or may be arranged in a curved path, such as a circle. It should further be appreciated that distinct sets of detector arrangements may be employed. For example, detectors may be configured into multiple distinct skewed arrays, or may be formed into a non-linear array as described above in relation to FIGS. 2 and 3.

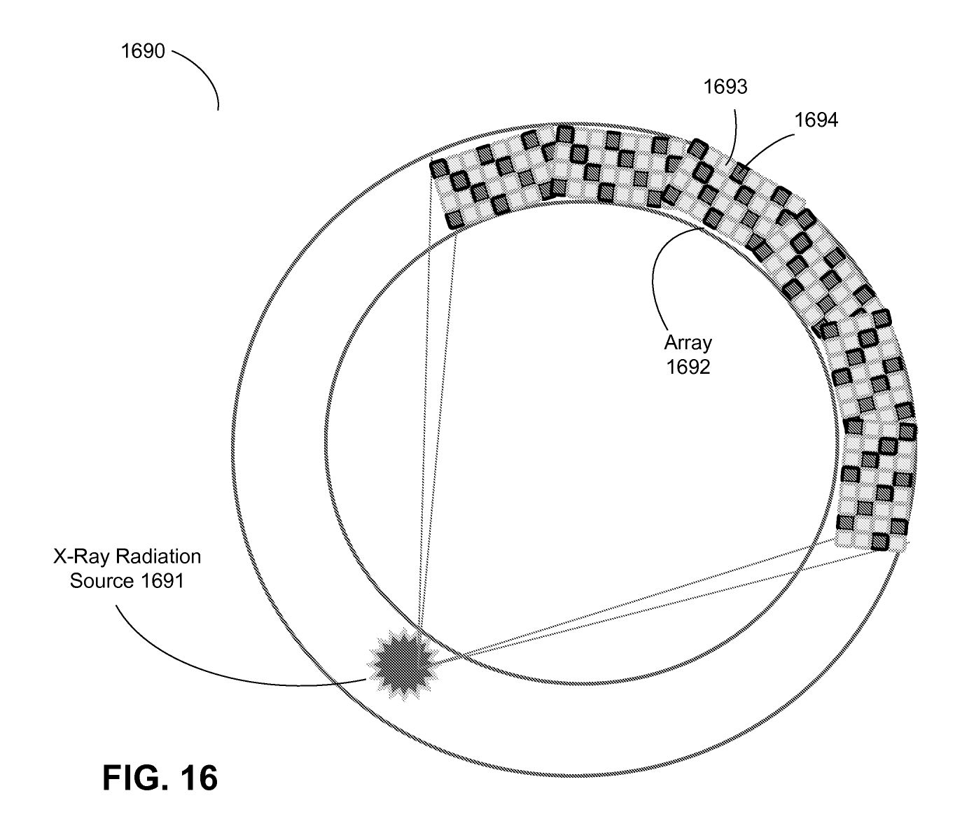

FIG. 16 is a sketch of a volumetric inspection system employing a rotating gantry configured with a two-dimensional array of detectors that are sensitive to X-ray radiation of different energy levels. In volumetric inspection system 2290, an X-ray radiation source 2291 illuminates a two-dimensional array of detectors of which a section is shown in the figure as array 2292. The two-dimensional array of detectors includes detectors sensitive to radiation of two different energy levels. In array 2292, detectors of each type are illustrated by shaded squares, wherein the dark squares indicate detectors sensitive to a first energy level, and the light squares indicate detectors sensitive to a second energy level. For example, in FIG. 22 detector 2293 indicates a detector sensitive to a first energy level, and detector 2294 indicates a detector sensitive to a second energy level.

As described above in connection with FIGS. 10A and 10B, a rotating gantry may be used to generate mechanical motion of an X-ray radiation source relative to an item under inspection in order to generate rays having different points of origin at different times. Such a system may employ a two-dimensional array of detectors, including those configurations described above. It will be appreciated that the relative fraction of each detector type and the regularity (or lack of regularity) of the detector pattern may be of any suitable nature, including those described above. For example, a rotating gantry may employ a one-dimensional array of detectors in a circle, may employ a two-dimensional array of detectors in a circle, may employ an array (either one-dimensional or two-dimensional) in an ellipse (e.g., a cylindric section of a circular rotating gantry), along a helical path, etc.

In the examples of FIGS. 12-16, arrays of detectors are achieved by interleaving in a single row detectors at different sensitivities. The pattern of detectors varies from row to row, such that no single row or column of the array contains detectors of the same sensitivity. Accordingly, in some embodiments, an array may consist of a nonfactorizable two-dimensional distribution of detectors of differing sensitivities.

However, in some embodiments, a row or column of an array may contain only detectors of the same sensitivity. Such rows or columns may be interleaved in the array at some ratio with respect to detectors of another sensitivity. Regardless of the distribution of detectors at different sensitivities, where gaps between adjacent detectors of the same sensitivity are created, interpolation techniques may be used to estimate a value that would have been measured had the gap been occupied by a detector of that same sensitivity. These interpolation techniques, in the case of a two-dimensional array, may be performed in two dimensions.

When multidimensional arrays are used, any suitable approach for illuminating the array with an X-ray source or sources may be used. In some embodiments, the entire array may be illuminated by a single source. Such illumination may result in each parallel line in the array creating a view of an item under inspection, with the views from different lines being skewed.

In other embodiments, distinctly positioned x-ray sources may be time-multiplexed in their illumination of the lines of detectors. In such a scenario, during each time-multiplexed interval when a distinctly positioned x-ray source is on, each array may be illuminated from a different angle, such that a different set of angular measurements may be collected during each time-multiplexed interval. Interpolation may be applied to each data set individually. Though, in some embodiments, information from one data set may be used to perform interpolation within a different data set.

The above described embodiments provide examples of an approach for obtaining atomic number information for multiple objects within an item under inspection using data collected with a limited number of detectors. Specifically, embodiments have been described in which dual energy, volumetric measurements are made with a detector array of like detectors.

Though, techniques as described above may be applied in other system configurations to achieve low cost, multi-energy volumetric images with high spatial resolution. Though, for example, the spatial resolution of an array may be decreased by filtering some of the detectors to acquire dual energy information, a volumetric reconstruction, whether using an iterative technique or filtered back projection, may result in an image with the full spatial resolution that would be possible based on the detector-to-detector pitch of the array. Such an image may be displayed, with objects given a visual appearance atomic number as well as density information obtained from the dual energy measurements, even with a limited number of detector of different sensitivities.

As illustrated by the embodiments above, such spatial resolution is possible by creating synthetic readings at the locations of detectors in the array that are sensitive to different energies than other detectors in the array. These synthetic readings may be created by various interpolation techniques using, in some embodiments, measurements from detectors with different sensitivities.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. In particular, the various aspects of the invention are not limited for use with any particular type of X-ray scanning device. The aspects of the invention may be used alone or in any combination and are not limited to the combinations illustrated in the embodiments of the foregoing.

For example, it is described that energy reaching some detectors in an array is filtered by application of a coating. It should be appreciated that the filter element need not touch the surface of the detectors. Rather, any positioning of the filter in a path of X-rays to the detector element may be suitable. Moreover, though it is described that a detector array with a plurality of detectors of the same type is converted into a first subset and a second subset of detectors sensitive to different energies by the selective placement of filtering elements, other implementations may be used. For example, the detectors may be of different type. Though, even in such an embodiment, sensitivity to different energies may be enhanced through the use of filtering.

As yet a further example, it is described that the un-filtered detector elements are used to form the volumetric image and the filtered detector elements are used for a second measurement to compute an effective atomic number of an object of interest. However, any selective positioning of filter elements may be used. For example, there may be more filtered elements than un-filtered elements such that the filtered detector elements could be used to compute the volumetric image and the un-filtered detector elements could be used to gather data for computing an effective atomic number.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

1. An inspection system, comprising:
an inspection area;
at least one x-ray source adapted to emit x-ray radiation into the inspection area at at least a first energy and a second energy;
a plurality of detectors being positioned to receive x-ray radiation from the at least one x-ray source after passing through the inspection area, the plurality of detectors comprising a first subset and a second subset; and
a plurality of filter elements positioned adjacent detectors of the second subset of the plurality of detectors.

2. The inspection system of claim 1, further comprising:
at least one processor constructed to construct a single-energy image of a slice through an item within the inspection area from outputs of the first subset of detectors when irradiated by the at least one x-ray source.

3. The inspection system of claim 2, wherein the at least one x-ray source, the first subset of detectors and the second subset of detectors are mounted in a linear array on a rotatable gantry.

4. The inspection system of claim 3, wherein:
the gantry has an opening therethrough;
the at least one x-ray source comprises an x-ray source mounted on the rotatable gantry on a first side of the opening;
the first subset of detectors are arrayed in an arc along a second side of the opening, the second side being opposite the first side; and
the second subset of detectors are interspersed between detectors of the first subset of detectors along the arc.

5. The inspection system of claim 2, wherein:
the at least one x-ray source comprises a continuous target, an electron gun adapted to emit an electron beam and a steering mechanism adapted to steer the electron beam across the target; and
the plurality of detectors comprise a U-shaped array of detectors adjacent the inspection area, the U-shaped array comprising detectors each of which is diametric a portion of the target.

6. The inspection system of claim 5, wherein:
detectors of the second subset of detectors are positioned at discrete locations along the U-shaped array.

7. The inspection system of claim 2, wherein the at least one processor is further configured to:
based on an object identified in the image of the slice, determine a position of a source of the at least one sources;
with the source of the at least one source in the determined position, read a value from a detector of the second subset of detectors; and
compute, based at least in part on the value read from the detector of the second subset of detectors and a value read from at least one of the first subset of detectors, an atomic number of the object.

8. The inspection system of claim 2, wherein:
the inspection system further comprises a conveyor passing through the inspection area, the conveyor adapted to move along an axis; and
the slice is perpendicular to the axis.

9. The inspection system of claim 1, wherein the second subset of detectors consists of fewer detectors than the first subset of detectors.

10. The inspection system of claim 1, wherein the second subset of detectors occupy a second area that is less than a first area of the first subset of detectors.

11. The inspection system of claim 10, wherein the second area is less than 10 percent of the first area.

12. The inspection system of claim 1, wherein the plurality of detectors are arranged in a linear array, the linear array having substantially equal spacing between detectors.

13. The inspection system of claim 1, wherein:
the source comprises a target disposed in a first plane; and
the plurality of detectors are arranged in one or more arrays each of the one or more arrays is disposed in a plane skewed with respect to the first plane.

14. The inspection system of claim 1, wherein the plurality of detectors are arranged in a two-dimensional array.

15. The inspection system of claim 14, wherein the at least one x-ray source and the two-dimensional array of detectors are mounted on a rotatable gantry.

16. The inspection system of claim 2, wherein the at least one processor is further configured to:
for locations occupied by detectors of the second subset of detectors, calculate data for the construction of the single-energy image of the slice by interpolating outputs of detectors of the first subset of detectors adjacent the locations occupied by the detectors of the second subset.

17. A method of operating an inspection system having at least one source and an array of detectors comprising at least a first plurality of detectors, the array comprising gaps between a portion of the first plurality of detectors, the method comprising:
measuring, with the first plurality of detectors, attenuation of x-rays from the source at a first energy by an object in an inspection area;
computing an image of a slice through the object based on the measured attenuation at the first energy and one or more computed values, wherein the computed values include values representative of attenuation of x-rays from the source to one or more of the gaps;
analyzing the image to determine whether an object of interest is present;
when an object of interest is present, selecting a source position and a detector of a second plurality of detectors such that a path between the selected source position and selected detector passes through the object of interest;
determining attenuation of x-rays at a second energy by the object in the inspection area along the path; and
computing an atomic number of the object based on the determined attenuation at the second energy and a portion of the measured attenuation at the first energy level.

18. The method of claim 17, wherein attenuation of x-rays at the second energy is determined along a path between the selected source position and a selected gap of one or more gaps.

19. The method of claim 17, wherein a path between a selected source position and selected detector of the second plurality of detectors passes through a filter element.

20. The method of claim 17, wherein:
the at least one source comprises a source mounted on a gantry; and
determining attenuation of x-rays at a second energy comprises measuring attenuation of x-rays at the second energy while rotating the gantry.

21. The method of claim 17, wherein:
determining attenuation of x-rays at the second energy by the object in the inspection area along the path comprises steering an electron beam to a location on a target corresponding to the selected source position.

22. The method of claim 17, wherein:
the first energy is 120-300 keV and the second energy is 50 keV-120 keV.

23. The method of claim 17, wherein selecting a source position and a detector of the second plurality of detectors comprises selecting the path based on positioning of the object of interest relative to other objects within the item under inspection.

24. The method of claim 21, wherein:
the first plurality of detectors and second plurality of detectors are interspersed in an array of a first length.

25. The method of claim 17, further comprising making a threat assessment of the item based at least in part on the computed atomic number.

26. The method of claim 17, wherein:
measuring the attenuation of x-rays at the first energy comprises performing a scan of an electron beam over a target to generate the x-rays from each of a plurality of locations on the target at each of a plurality of respective times;
determining attenuation of x-rays at the second energy level comprises selecting an output of the selected detector for a time during the scan when the electron beam strikes the target in a location corresponding to the selected position.

27. A method of operating an inspection system having at least one source and an array of detectors comprising a plurality of detectors, the method comprising:
measuring, with the plurality of detectors, attenuation of x-rays from the source at a first energy by an object in an inspection area; and
computing an image of a slice through the object based on the measured attenuation at the first energy,
wherein:
the plurality of detectors comprise a first subset and a second subset, the detectors of the first subset having a first sensitivity and the detectors of the second subset having a second sensitivity; and
computing the image comprises deriving a synthetic reading at the first sensitivity at a location occupied by a detector in the second subset.

28. The method of claim 27, wherein:
deriving the synthetic reading comprises deriving the synthetic reading based on measurements made with at least a portion of the detectors in the first subset and a portion of the detectors in the second subset.

29. The method of claim 27, wherein:
computing the image comprises performing filtered back projection and/or iterative reconstruction on data measured from the first subset of detectors and the synthetic reading.

30. The method of claim 27, wherein:
the plurality of detectors are arranged in an array with a detector-to-detector pitch; and
the computed image comprises dual-energy information and has a spatial resolution corresponding to the detector-to-detector pitch.

31. The inspection system of claim 1, wherein:
the inspection system is configured to measure, with the plurality of detectors, attention, by an object within the inspection area, of x-ray radiation from the at least source; and
the inspection system further comprises a processor configured to compute a volumetric image comprising atomic number information about an object in the inspection area based on attention of x-ray radiation from the at least source, by the object within the inspection area, measured with the plurality of detectors.

32. The inspection system of claim 31, wherein:
the processor is configured to compute the volumetric image presenting atomic number information based at least in part on computing a single energy volumetric image based on outputs of the first subset of the plurality of detectors.

33. The inspection system of claim 32, wherein:
the processor is configured to compute the volumetric image using an iterative reconstruction technique.

34. The inspection system of claim 33, wherein:
wherein the first subset and the second subset comprise approximately equal numbers of detectors.
